(19) United States
(12) Patent Application Publication
(10) Pub. No.: US 2017/0178076 A1
(43) Pub. Date: Jun. 22, 2017

(54) SYSTEMS, METHODS, AND APPARATUS FOR COLLABORATIVE EXCHANGE

(71) Applicant: FACEBOOK, INC., MENLO PARK, CA (US)

(72) Inventors: Christopher William Jones, Mill Valley, CA (US); Keenan Pridmore, Chicago, IL (US)

(21) Appl. No.: 14/972,640

(22) Filed: Dec. 17, 2015

(51) Int. Cl. G06Q 10/10; G06Q 50/00; H04L 12/58

(52) U.S. Cl. CPC G06Q 10/103; H04L 51/32; G06Q 50/01

(57) ABSTRACT

Exemplary methods, apparatuses, and systems for collaborative exchange are detailed. For example, in an embodiment a computer-implemented method comprises receiving parameters for a collaborative exchange, curating a collection of items for the collaborative exchange based upon the received parameters, transmitting the collection of items to participants of the collaborative exchange, receiving selections of items from the participants of the collaborative exchange, and upon all participants having a turn at selecting an item, initiating shipment of the selected items.

### FIELD

The various embodiments described herein relate to collaborative exchange. In some embodiments, the collaborative exchange is of items.

### BACKGROUND

Social networking systems enable users to interact with various objects represented within the social network. For example, a social networking system allows users to designate other users or entities as connections (or otherwise connect to, or form relationships with, other users or entities), contribute and interact with their connections, post media or commentary, share links to external content, use applications, join groups, list and confirm attendance at events, invite connections, and perform other tasks that facilitate social interaction. External applications also use the services of a social networking system to allow authenticated users to incorporate some of the above social interactions with use of the external applications. Similar interactions may also be a part of the user experience within other network services.

### SUMMARY OF THE DESCRIPTION

Exemplary methods, apparatuses, and systems for collaborative exchange are detailed.

In one embodiment, parameters for a collaborative exchange are received. For example, users, a price range, product selection, etc. A collection of items for the collaborative exchange is curated based upon the received parameters allowing for participants of the exchange to select from this collection. The collection of items is transmitted to participants of the collaborative exchange and their selections of items is received. Upon all participants having a turn at selecting an item the shipment of the selected items occurs.

Other features and advantages will be apparent from the accompanying drawings and from the detailed description.

### BRIEF DESCRIPTION OF THE DRAWINGS

The present invention is illustrated by way of example and not limitation in the figures of the accompanying drawings, in which like references indicate similar elements, and in which:

FIG. 1 illustrates an example network environment of a system including a social networking system;

FIG. 2 illustrates exemplary graph of social network data;

FIGS. 3-7 illustrate embodiments of graphical user interfaces (GUIs) to be used in a collaborative exchange application;

FIG. 8 illustrates an embodiment of a method for collaborative exchange;

FIG. 9 illustrates an embodiment of a method for collaborative exchange;

FIG. 10 illustrates an embodiment of an overall flow for collaborative exchange; and

FIG. 11 illustrates, in block diagram form, an exemplary processing system to perform collaborative exchange.

### DETAILED DESCRIPTION

Social networking systems benefit from techniques that improve an ability of users to interact. One type of interaction is a collaborative exchange of items. For example, users purchase items to be put into a pool and selected by participants of that pool. This allows for friends that are physically distant from each other to participate in, for example, an item exchange.

In the following description, numerous specific details are set forth. However, it is understood that embodiments of the invention may be practiced without these specific details. While a social networking system is used to describe embodiments of preview generation for online content, it will be understood that these concepts are generally applicable to generating previews for online content for other network services/entities, websites, etc. References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

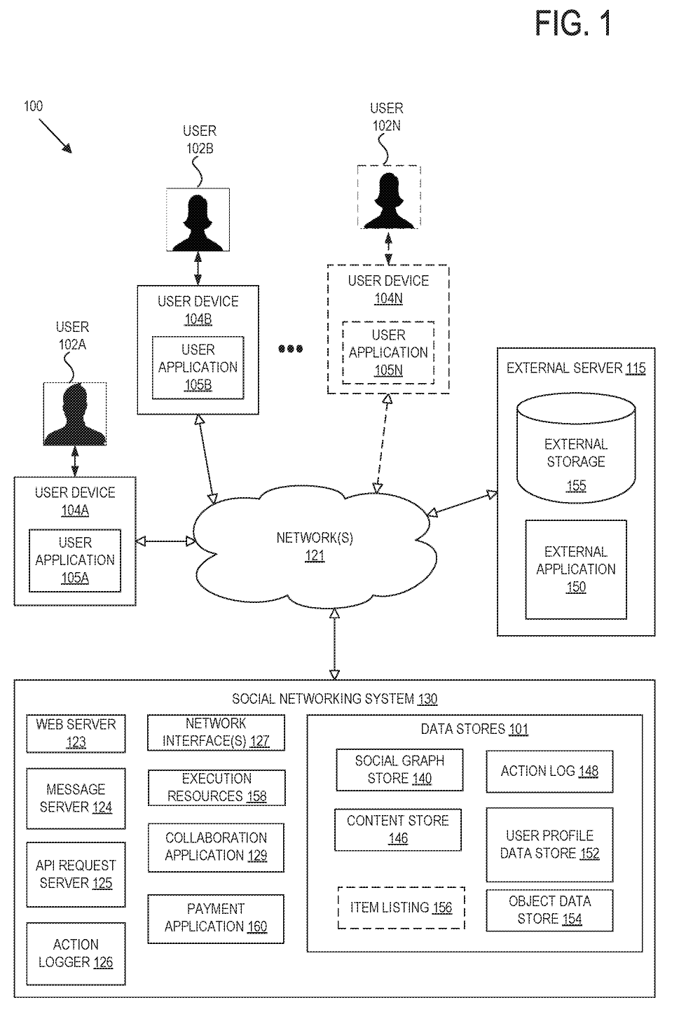

FIG. 1 illustrates an example network environment of a system 100 including a social networking system 130 that offers its users 102A-102N the ability to communicate and interact with other users 102A-102N and entities of the social networking system 130 according to an embodiment of the invention. The illustrated social networking system 130 includes a content creator identification analysis module 129 for automatically identifying content creators from resources shared between users of the social networking system in accordance with an embodiment of the invention.

In some embodiments, the social networking system 130 comprises one or more computing devices storing user profiles associated with users 102A-102N and/or other objects, as well as connections between users and other users 102A-102N and/or objects.

The user devices 104A-104N that are enabled to interact with social networking system 130 can be any type of computing device capable of receiving user input as well as transmitting and/or receiving data via a network (e.g., network 121). For example, the user devices 104A-104N can include conventional computer systems, such as a desktop or laptop computer, or may include devices having computer functionalities such as Personal Digital Assistants (PDA), cellular or mobile telephones, smart-phones, in- or out-of-car navigation systems, gaming devices, or other electronic devices.

In one embodiment, a user device (e.g. 104A) may execute a user application (e.g. 105A) allowing a user 102A of the user device 104A to interact with the social networking system 130. For example, the user application 105A may be a web browser application (e.g., Microsoft Windows Internet Explorer, Mozilla Firefox, Apple Safari, Google Chrome, Opera, etc.). In an embodiment, the user application 105A is a special-purpose client application (e.g., Facebook for iPhone or iPad, etc.), and in an embodiment the user application 105A is the native operating system of the user device 104A, such as Windows®, Mac OSX®, IOS®, or ANDROID™, which may utilize an Application Programming Interface (API) to directly interface with the social networking system 130 through API request server 125.

The user devices 104A-104N are configured to communicate with the social networking system 130 via a network 121 or collection of networks—such as the Internet, a corporate Intranet, a Virtual Private Network (VPN), a Local Area Network (LAN), a Wireless Local Area Network (WLAN), a cellular network, a Wide Area Network (WAN), a Metropolitan Area Network (MAN), or a combination of two or more such networks. The network 121 may be wired, wireless, or a combination of both. In one embodiment, the network 121 uses standard communications technologies and/or protocols. Thus, the network 121 may include links using technologies such as Ethernet, Institute of Electrical and Electronics Engineers (IEEE) 802.11, Worldwide Interoperability for Microwave Access (WiMAX), 3G, 4G, Long Term Evolution (LTE), Code-Division Multiple Access (CDMA), Digital Subscriber Line (DSL), cable modems, etc. Similarly, the networking protocols used on the network 121 may include Multiprotocol Label Switching (MPLS), Transmission Control Protocol (TCP), Internet Protocol (IP), TCP/IP, User Datagram Protocol (UDP), Hypertext Transport Protocol (HTTP), Simple Mail Transfer Protocol (SMTP), and/or File Transfer Protocol (FTP). Data exchanged over the network 121 may be represented using technologies and/or formats including Hypertext Markup Language (HTML), Extensible Markup Language (XML), or JavaScript Object Notation (JSON), among other formats. In addition, all or some of links can be encrypted using conventional encryption technologies such as Secure Sockets Layer (SSL), Transport Layer Security (TLS), or Internet Protocol security (IPsec).

The social networking system 130 fundamentally relies upon information representing its users 102A-102N and a set of objects. Users 102A-102N, using the social networking system 130, may add connections to other users or objects of the social networking system 130 to which they desire to be connected, and may also interact with these other users or objects. The users of the social networking system 130 are individuals (e.g. humans), and the objects may include entities (such as businesses, organizations, universities, manufacturers, brands, celebrities, etc.), concepts, or other non-human things including but not limited to a location, an album, an article, a book, a concept, etc.

In some embodiments, the social networking system 130 also allows users to interact with external (e.g., third-party) applications 150 (e.g., websites), external storage 155, and/or external servers 115 (e.g., server end stations).

Based on the stored data about users, objects, and the connections between the users and/or objects, the social networking system 130 generates and maintains a “social graph” in a social graph store 140 comprising a plurality of nodes interconnected by a plurality of edges. Each node in the social graph represents a user or object that can act on another node and/or that can be acted on by another node. An edge between two nodes in the social graph represents a particular kind of connection between the two nodes, which may result from an action that was performed by one of the nodes on the other node. For example, when a user identifies an additional user as a friend, an edge in the social graph is generated connecting a node representing the first user and an additional node representing the additional user. The generated edge has a connection type indicating that the users are friends. As various nodes interact with each other, the social networking system 130 adds, removes, or otherwise modifies edges connecting the various nodes to reflect the interactions.

To provide these functionalities, the embodiment of the social networking system 130 includes an API request server 125, a web server 123, a message server 124, an action logger 126, and a set of data stores 101. This embodiment also includes, within the data stores 101, a social graph store 140 including a node store 142 and an edge store 144, as well as a content store 146, an action log 148, a user profile data store 152, and an object data store 154. In other embodiments, the social networking system 130 may include additional, fewer, or different modules for various applications. Of course, conventional components such as processors, memories, security mechanisms, load balancers, failover servers, management and network operations consoles, and the like are not shown in FIG. 1 so as to not obscure the details of the system.

The social networking system 130 allows its users 102A-102N to communicate or otherwise interact with each other and access content, as described herein. The social networking system 130 stores user profiles in the user profile data store 152. A user profile includes declarative information about the user that was explicitly shared by the user, and may also include profile information inferred by the social networking system 130. In one embodiment, a user profile includes multiple data fields, each data field describing one or more attributes of the corresponding user of the social networking system 130. The user profile information stored in user profile data store 152 describes the users 102A-102N of the social networking system 130, including biographic, demographic, and other types of descriptive information, such as work experience, educational history, gender, relationship status, hobbies, location, other preferences, and the like. The user profile may also store information provided by the user. For example, images or videos provided by the user may also be stored within the user profile. In other embodiments only textual data of the user is stored in the user profile and other data (e.g., images, videos) are stored in multimedia stores and associated with the user (e.g., through associating a user identifier of the user with an image/video identifier of the multimedia content). In certain embodiments, images or videos including or depicting users of the social networking system 130 may be “tagged” with identification information of those users. A user profile in the user profile data store 152 may also maintain references to actions (stored in the user profile or in an action log 148) by the corresponding user performed on content items in a content store 146 and stored in an edge store 144. A user may also specify one or more privacy settings, which are stored in that user's user profile. Privacy settings limit information that the social networking system 130 or other users of the social networking system 130 are permitted to access from that user's user profile.

The web server 123 links the social networking system 130 via the network 121 to one or more user devices 104A-104N by accepting requests for from the user devices 104A-104N and/or transmitting web pages or other web-related content to the user devices 104A-104N, such as image files, audio files, video files, Java applets, Flash, XML, JavaScript, Cascading Style Sheets (CSS), and so forth. The web server 123 in some embodiments is configured to utilize a set of one or more network interfaces 127 to send and receive messages across the network 121. In some embodiments the web server 123 (additionally or alternately) utilizes a message server 124 (e.g., a dedicated server end station, a dedicated software application, etc.) to communicate with the user devices 104A-104N, which is operative to send and/or receive instant messages, queued messages (e.g., email), text and SMS (Short Message Service) messages, or utilize any other suitable messaging technique.

In some embodiments, a message sent by a user to another user by way of the social networking system 130 can be viewed by other users of the social networking system 130, for example, by certain connections of the user (directly connected users in the social graph, other users more than one hop away in the social graph, etc.) receiving the message. An example of a type of message that can be viewed by other users of the social networking system 130 (besides the recipient of the message) is commonly known as a wall post. In some embodiments, a user can send a private message to another user that can only be retrieved by the other user. These messages are stored in storage such as message store 1

When a user takes an action within the social networking system 130, the action may be recorded in an action log 148 by an action logger 126, subject to any privacy settings and restrictions of the user and/or social networking system 130. In one embodiment, the social networking system 130 maintains the action log 148 as a database of entries. When an action is taken on the social networking system 130, the social networking system 130 can add an entry for that action to the action log 148. In accordance with various embodiments, the action logger 126 is capable of receiving communications from the web server 123 about user actions on and/or off the social networking system 130. The action logger 126 populates the action log 148 with information about those user actions. This information may be subject to privacy settings associated with the user. Any action that a particular user takes with respect to another user is associated with each user's profile, through information maintained in a database or other data repository, such as the action log 148. Examples of actions taken in the social networking system 130 that may be stored in the action log 148 include, but are not limited to, adding a connection to another other user, sending a message to the other user, reading a message from the other user, viewing content (e.g., wall posts, images, videos) associated with or created by the other user, attending an event posted by another user, being tagged in photos with another user, etc. In some embodiments, certain actions are described in connection with more than one user, and these actions may be associated with those users as well and stored in the action log 148.

The action log 148 may be used by the social networking system 130 to track other user actions on the social networking system 130, as well as actions on an external application 150 (e.g., website) that are communicated to the social networking system 130. Users may interact with various objects on the social networking system 130, including commenting on posts, sharing links, and checking-in to physical locations via a mobile device, accessing content items in a sequence or other interactions. Information describing these actions is stored in the action log 148. Additional examples of interactions with objects on the social networking system 130 included in the action log 148 include logging in to the social networking system 130, commenting on a photo album, communications between users, becoming a fan of a musician or brand by “liking” a page of the respective entity, adding an event to a calendar, joining a group, creating an event, authorizing an application, using an application, and engaging in a transaction. Additionally, the action log 148 records a user's interactions with advertisements on the social networking system 130 as well as other applications operating on the social networking system 130. In some embodiments, data from the action log 148 is used to infer interests or preferences of the user, augmenting the interests included in the user profile and allowing a more complete understanding of user preferences.

The API request server 125 allows external systems (e.g., an external application 150 of external server 115, and/or user applications 105A of user devices 104A-104N) to access information from or transmit information to the social networking system 130 by issuing API calls. The information provided by the social networking system 130 may include user profile information or the connection information of users, subject to the individual privacy settings of the user. For example, a system (e.g. external application 150) may send an API request to the social networking system 130 via the network 121 to publish a story on behalf of a user, request information about a user (after having been given permission to do so by the user), upload a photograph on behalf of a user, etc. API requests are received at the social networking system 130 by the API request server 125, which then processes the request by performing actions sought by the API requests, determining appropriate responses to the API requests, and transmitting back these responses back to the requesting application 150 via the network 121.

The content store 146 stores content items associated with user profiles, such as posts, images, videos, and/or audio files. Content items from the content store 146 may be displayed when a user profile is viewed or when other content associated with the user profile is viewed. For example, displayed content items may show images or video associated with a user profile or show text describing a user's status. Additionally, other content items may facilitate user engagement by encouraging a user to expand his connections to other users or entities, to invite new users to the system or to increase interaction with the social network system 130 by displaying content related to users, objects, activities, or functionalities of the social networking system 130. Examples of social networking content items include suggested connections or suggestions to perform other actions, media provided to or maintained by the social networking system 130 (e.g., pictures, videos), status messages or links posted by users to the social networking system, events, groups, pages (e.g., representing an organization or commercial entity), and any other content provided by, or accessible via, the social networking system 130.

The content store 146 also includes one or more pages associated with entities included social graph store 140. An entity is a type of object that can be a non-individual user of the social networking system 130, such as a business, a vendor, an organization, or a university. However, in some embodiments of the invention, an entity may represent a celebrity or other well-known individual, and thus an entity object node for a person may exist in the social graph (serving as a “brand” for that individual, and perhaps having an associated page that other users may “like”) and also a user node for that same person may also exist in the social graph (serving as a representation for a personal account of that person). A page includes content associated with an entity and instructions for presenting the content to a user of the social networking system 130. For example, a page identifies content associated with the entity's stored content (from the object data store 154) as well as information describing how to present the content to users viewing the page.

In the depicted embodiment, the social networking system 130 includes collaboration application 129 to be executed on a processor of the social networking system 130. The collaboration application 129 performs one or more functions for providing collaboration exchange using the social networking system 130. For example, the collaboration application 129 performs one or more of: 1) receiving and storing exchange parameters (detailed below); 2) updates collaboration exchange graphical user interfaces and hosts the exchange; 3) processes payment; and 4) initiates shipment. In some embodiments, the external sever 115 provides the functionality of the collaborative exchange and includes the necessary information do that including, but not limited to, a payment application, a collaboration application, item listing, action log, etc.

Item listing 156 is a listing of items in a collaborative exchange. This listing may also include catalogs of types of items, price ranges, etc. and may communicate with vendors to be kept up-to-date. Payment application 160 also for the social networking system 130 to process payments for items of a collaborative exchange.

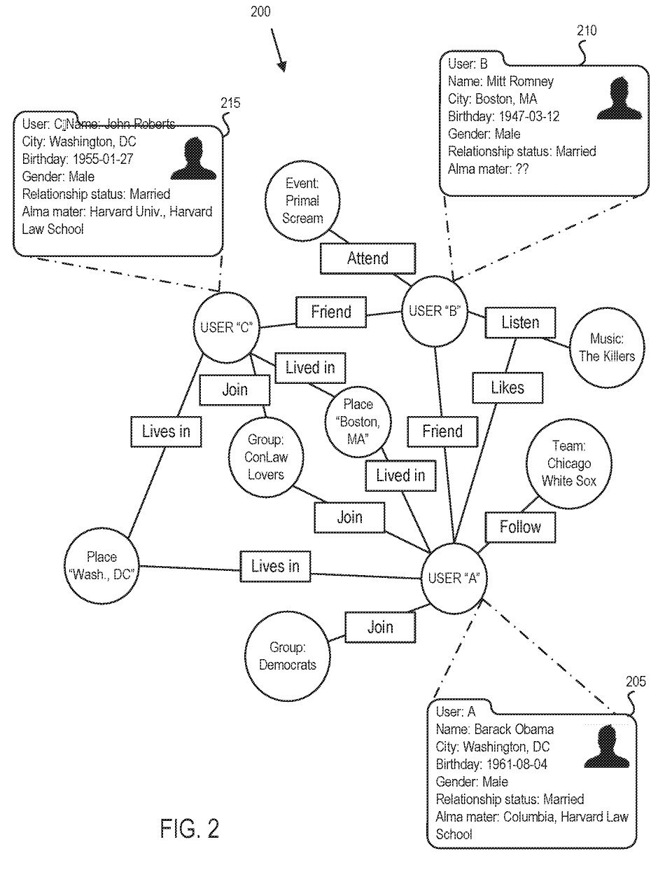

FIG. 2 illustrates an exemplary graph 200 of social network data. In graph 200, objects are illustrated as circles and actions are illustrated as labeled connections between circles. Developers of the social network or corresponding social network applications define actions to represent different ways that users may interact with the social network and/or their applications. As users perform actions, connections are made between users and objects. For example, User A has performed a number of actions within the social network, indicating that he previously lived in Boston, currently lives in Washington D.C., joined groups for Democrats and ConLaw Lovers, is following the White Sox, and is friends with User B. User B and User C have also performed a number of actions with respect to objects within graph 200.

In one embodiment, users are able to add demographic information to user profiles 205-215. In one embodiment, for demographic information that has not been entered by a user, a social network application generates an estimate based upon the user's actions, connections, and/or actions of connections. For example, User B has not entered an alma mater into user profile 210. A social network application may determine from User B's contacts, activities, cities of residence, etc. that User B's likely alma mater is one or both of Brigham Young University and Harvard University. In one embodiment, the user profiles 205-210 include additional information, such as relationships to other users, places where the user has worked, user interests, etc.

In one embodiment, users are able to provide feedback on actions of other users/entities. As a result, actions are also viewed as objects that may be acted upon. For example, User B listened to music by the artist, The Killers. As a result, the social networking system publishes a narrative associated with User B (e.g., in a newsfeed, profile of User B, etc.) indicating that User B listened to music by the artist, The Killers. In viewing a newsfeed, profile of User B, or another form of social networking system publication(s), the social networking system displays the narrative to User A. The social networking system then receives input from User A indicating that User A “likes” that User B listened to The Killers.

In one embodiment, demographic data further includes a weight or score indicating an affinity between a user and an object. For example, repeated user action with one object may indicate a stronger affinity for said object than another object with which the user has limited interaction. First degree connections, e.g., the friendship between User A and User B, may indicate a stronger affinity than second degree connections, e.g., User A is friends with User B, who is friends with User C, creating a second degree connection between User A and User C. An indication that two users are married may indicate a stronger affinity than if two users are friends. Additionally, temporal and geographic proximity of actions/users are other exemplary indicators of affinity.

In one embodiment, users may select privacy settings to control what network service data is shared, with whom the data is shared, and/or what data used for selecting candidate objects.

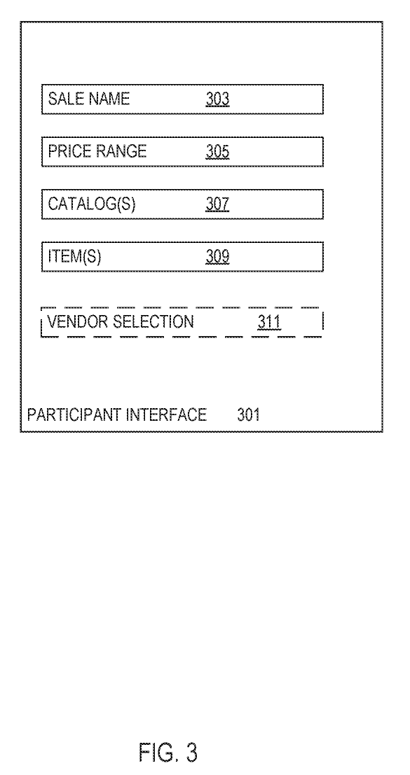

FIGS. 3-7 illustrate embodiments of graphical user interfaces (GUIs) to be used in a collaborative exchange application. These GUIs are presented on a user device as a part of a standalone application, embedded application, a browser window, etc. Additionally, while these GUIs are illustrated separately, in some embodiments, aspects of various GUIs are combined (for example, user selection may be included in a GUI for initiation).

FIG. 3 illustrates an embodiment of a graphical user interface (GUI) for a collaborative exchange application. In particular, this GUI is an illustrative example of a GUI for initializing a collaborative exchange. The user interface 301 includes several fields typically used in a collaborative exchange. Information provided by a user into these fields is stored locally on the user's device and/or transmitted to a back-end provided by a social networking system and/or vendor.

A field for naming the exchange 303 allows a user to input a name for the collaborative exchange. For example, a user may type in “Holidays 2015” as the name. Users may participate in more than one exchange and having a name allows for differentiation between exchanges.

A field for giving a price range for the exchange 305 allows a user to input a price range/limit for the collaborative exchange (if desired). For example, a user may type in $5-10, or <$50. This range/limit is used to select items for purchase.

A field for catalogs for the exchange 307 allows a user to select a catalog of items for the collaborative exchange. In some embodiments, this field 307 is a dropdown menu. In other embodiments, the field 307 allows for the user to type in a catalog. Autofill may be used to complete a catalog entry. In other embodiments, images associated with the catalogs are shown in the user in this field 307 for the user to select a particular catalog.

A field for showing items of a catalog the exchange 309 allows a user to see items in a catalog. For example, if the catalog is sports, the user may be provided with images of sports equipment.

In some embodiments, what is shown in a particular field varies depending upon previously input information. For example, if there are no items in a catalog that fit an input price range, then that catalog is not shown or is shown in a different color (for example, greyed out). Or, if a catalog or item was selected first, the price range may be tentatively filled in for the initiating user to see what is available.

In some embodiments, a vendor selection field 311 is provided to allow the initiating user to select which vender is to supply the items for the exchange.

In some embodiments, a participant is presented with a similar GUI to select an item to add to the pool of items to exchange. However, aspects such as price range 305 and catalog(s) 307 are locked.

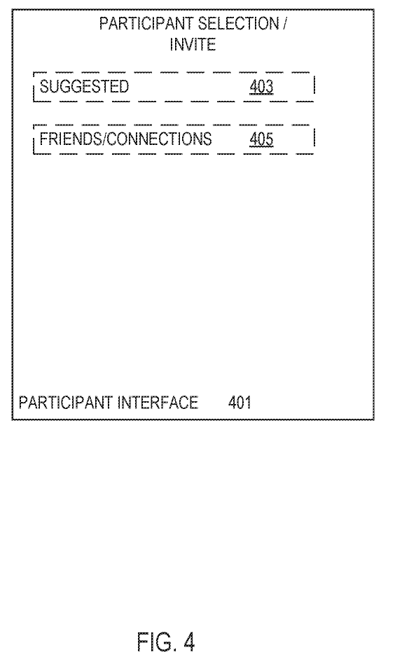

FIG. 4 illustrates an embodiment of a graphical user interface (GUI) for a collaborative exchange application. In particular, this GUI 401 is an illustrative example of a GUI for selecting participants of a collaborative exchange. Depending upon the implementation, an initiating user either selects users to participate in the exchange from a list that is provided to him/her (from e.g., a social network using social signals such as social proximity in a social graph, geographic data, personal data, etc.) or selects his/her friends from the social network, or the application and/or its its backend selects participants for the user (e.g., using social signals such as social proximity in a social graph, geographic data, personal data, etc.) without user input. In some embodiments, geographic disparity is weighted higher than other signals such that participants are not local to each other. For suggested participants, the backend may look at posts, likes, product names, entity detection, social affinity, etc. to select participants. Typically, the selection looks for a high co-efficiency in relationship (e.g., as dictated by a graph), but a disparate physical location. When the participant selector GUI is a part of an initiation GUI, the application (or backend) may also provide suggestions as to what items are to be curated based on the initial parameters and participating users.

A field for suggested participants for the exchange 403 is provided by a back-end (such as a social networking system). This field may include a plurality of names and/or pictures of these people. In some embodiments, links to social networking profiles are included. These friends are selectable by the user through the GUI.

A field for inputting participants for the exchange 405 allows a user to input participant information such as a name and a way to contact that person (for example, email address, social networking user name, etc.).

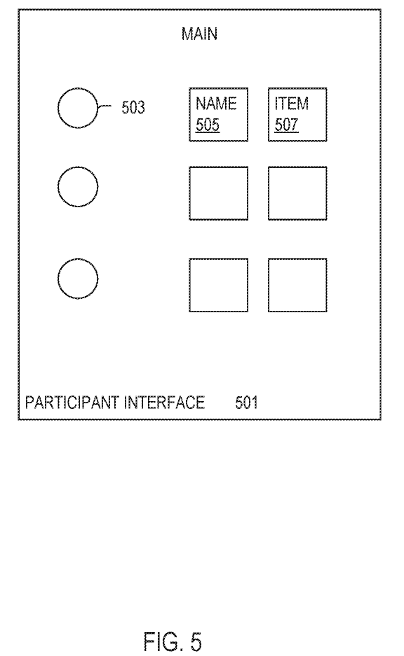

FIG. 5 illustrates an embodiment of a graphical user interface (GUI) for a collaborative exchange application. In particular, this GUI 501 is an illustrative example of a GUI a main screen (feed) for participants of the exchange. In this GUI, participants of the exchange are shown in their order of selection of the exchange. The order of selection may be one of random, by birthday, by date of joining the exchange, etc.

The GUI provides images 503 and names 505 of the participants. The GUI also provides an indication of a product 507 selected by the participant. Typically, this indication is in the form of an image. In some embodiments, for participants that have not yet selected an item a placeholder is used for the product indication.

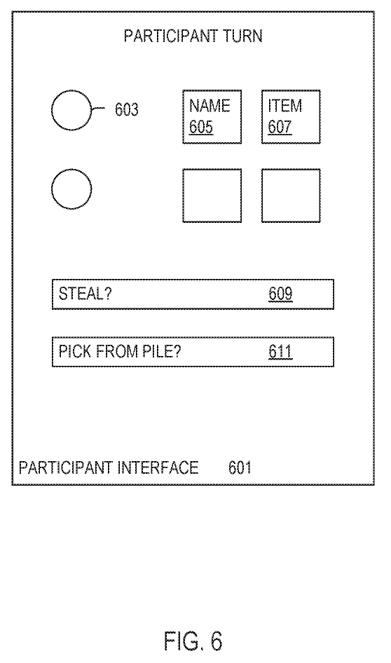

FIG. 6 illustrates an embodiment of a graphical user interface (GUI) for a collaborative exchange application. In particular, this GUI 601 is an illustrative example of a GUI a main screen (feed) for participants of the exchange during a user's turn. In this GUI, participants of the exchange are shown in their order of selection of the exchange. The order of selection may be one of random, by birthday, by date of joining the exchange, etc.

The GUI provides images 603 and names 605 of the participants. In some embodiments, one or both of images 603 and names 605 are a link to a profile such as a social networking system profile. The GUI also provides an indication of a product 607 selected by the participant. Typically, this indication is in the form of an image. In some embodiments, for participants that have not yet selected an item a placeholder is used for the product indication.

The user whose turn is up may choose to steal 609 an existing item, or pick from the curated items 611. In some embodiments, a steal 609 is performed by selecting an item and performing a “swipe” across the item. In some embodiments, to steal (or swipe) requires the stealing user to first perform an action (such as donate to charity, perform a task, etc.).

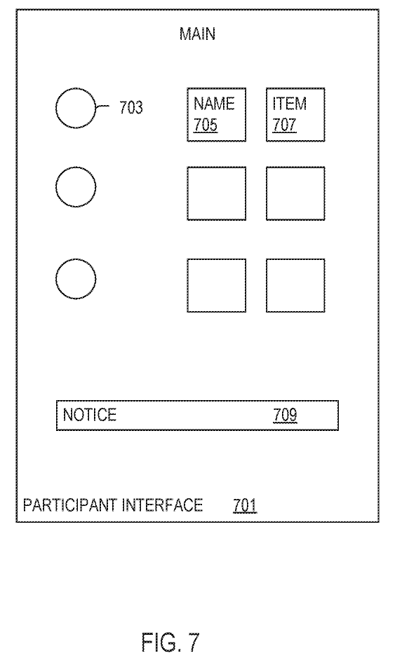

FIG. 7 illustrates an embodiment of a graphical user interface (GUI) for a collaborative exchange application. In particular, this GUI 701 is an illustrative example of a GUI a main screen (feed) for participants of the exchange during a user's turn. In this GUI, participants of the exchange are shown in their order of selection of the exchange. The order of selection may be one of random, by birthday, by date of joining the exchange, etc.

The GUI provides images 703 and names 705 of the participants. The GUI also provides an indication of a product 707 selected by the participant. Typically, this indication is in the form of an image. In some embodiments, for participants that have not yet selected an item a placeholder is used for the product indication. Additionally, the GUI provides a notice 709 of the latest action(s) since the user viewed the exchange.

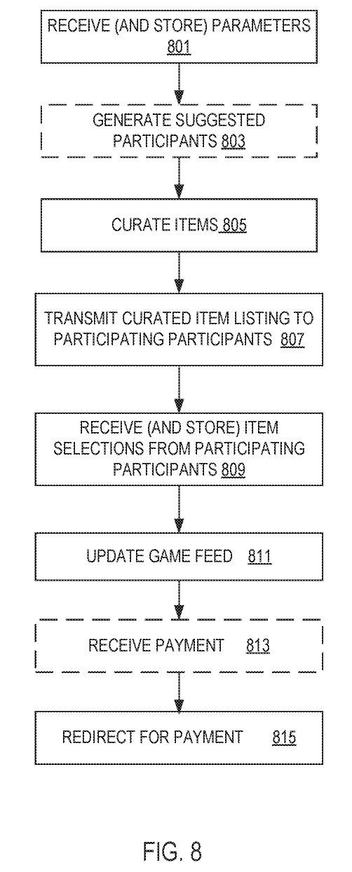

FIG. 8 illustrates an embodiment of a method for collaborative exchange. In some embodiments, this method is performed by one or more servers (such as a social networking server and/or a third party server). In these embodiments, the one or more servers receive and present information via GUIs to end-users. In other embodiments, certain aspects of the method are performed on an end-user device, for example, via an application, browser, etc.

Parameters of the exchange are received and stored at 801. For example, an initiating user using a GUI (such as detailed with respect to FIG. 3) provides parameters for an exchange such as a: 1) a range; 2) participants; 3) an exchange name; 4) a selected catalog; 5) a vendor selection; 6) an item selection to contribute to the exchange; and/or 7) payment and shipping information.

In some embodiments, suggested users/participants are generated at 803. Depending upon the implementation, an initiating user either selects users to participate in the exchange from a list that is provided to him/her (from, e.g., a social network using social signals such as proximity, geographic data, personal data, etc.) or selects his/her friends from the social network, or the application and its backend selects participants for him/her (e.g., using social signals such as proximity, geographic data, personal data, etc.) without input. For suggested participants, the backend may look at posts, likes, product names, entity detection, social affinity, etc. to select participants. Typically, the selection looks for a high co-efficiency in relationship (e.g., as dictated by a graph), but a disparate physical location.

Items for the exchange are curated at 805 based on the input parameters and are transmitted to the participants at 807.

Each participant selects an item for the exchange from the items provided in his/her GUI to be a part of the exchange and those are received and stored at 809.

The feed for the exchange is updated and transmitted to the participants at 811 and is updated as items are selected or swiped.

In some embodiments, upon selection by each participant, payment is received at 813. For example, payment is received by payment application 160 and processed.

In other embodiments, upon selection by each participant, payment is redirected at 815. For example, payment is forwarded to the vendor for processing.

After payment is complete, transfer of the item is initiated by the vendor.

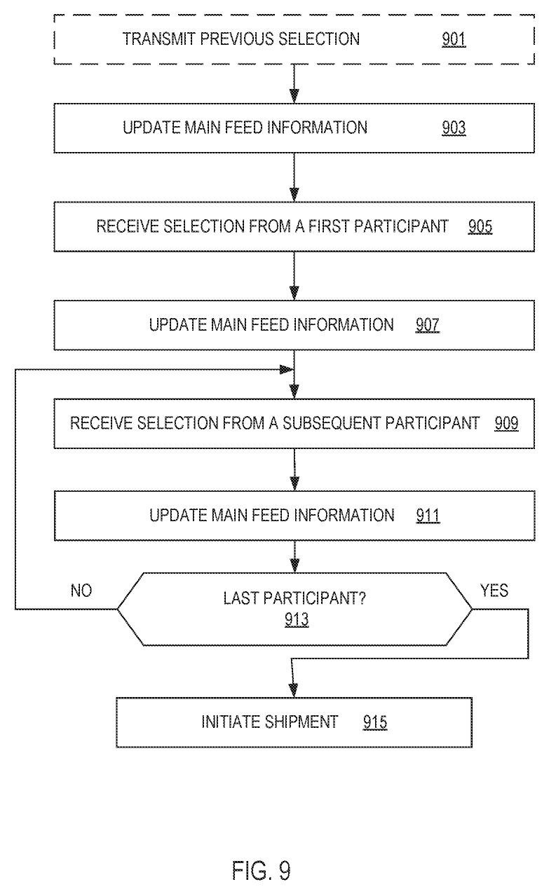

FIG. 9 illustrates an embodiment of a method for collaborative exchange. In particular, this method applies to updating a feed for collaborative exchange. In some embodiments, this method is performed by one or more servers (such as a social networking server and/or a third party server). In these embodiments, the one or more servers receive and present information via GUIs to end-users. In other embodiments, certain aspects of the method are performed on an end-user device, for example, via an application, browser, etc.

A selection (swipe or new item) is received from a first participant at 901. In some embodiments, a participant has a limited amount of time to select. The feed for the collaborate exchange is updated with the selection at 903 and transmitted to the participants for display.

A selection (swipe or new item) is received from a second participant at 905. In some embodiments, a participant has a limited amount of time to select. The feed for the collaborate exchange is updated with the selection at 903 and transmitted to the participants for display.

A determination of if the last participant has selected is made at 909. If not, a selection (swipe or new item) is received from a different participant at 905. When the last participant has gone, the shipment and/or payment process is initiated. Note that until this occurs no products have been shipped. These products may be stored by the vendor or by the social network.

In contrast to the turn based approach detailed above, in some embodiments the exchange is one of “free for all” allowing users to rush to select. In other embodiments, selection order is dictated by games of skill performed by the participants.

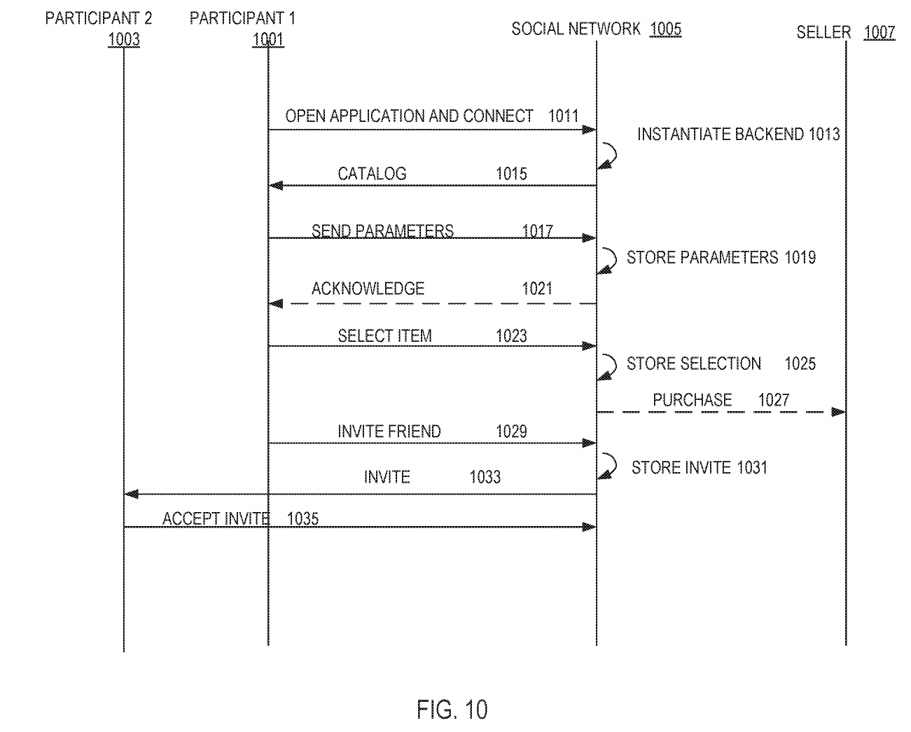

FIG. 10 illustrates an embodiment of an overall flow for collaborative exchange. User 1 1001 opens the collaborative exchange application, webpage, etc. and connects to the social network 1005 at 1011.

The social network 1005 instantiates a back-end to support the exchange such as initiating the collaboration application 129 at 1013.

The social network 1005 transmits a listing of catalogs at 1015. This catalog is viewable by User 1 1001 when he/she makes a decision as to the parameters of the exchange such as price range, vendor, name, etc. The parameters are sent by User 1 1001 at 1017. In some embodiments, the catalog listing is not sent until after other parameters are received by the social networking system.

The social network 1005 stores received parameters at 1019 and in some embodiments acknowledges them at 1021.

User 1 1001 selects an item and transmits that selection to the social network 1005 at 1023. The social network 1005 stores the received selection at 1025 and in some embodiments causes a purchase at 1027 from the seller 1009.

User 1 1001 invites one or more participants and transmits that to the social network 1005 at 1029. The social network 1005 stores the invites at 1031 and sends an invite to the participates (such as User 2 1003) at 1033.

User 2 1003 accepts the invite at 1035 and the exchange begins and the participants play at 1037. Upon completion of the exchange, payment is sent by either the participants or the social networking system to the seller 1007 at ZZB39 which then ships the items at 1041.

In some embodiments, there is no social network 1005 and most, if not all, of the operations shown as being performed by the social network 1005 are instead performed by the seller 1009. However, it is contemplated that the application run by the users can perform all steps including providing instructions for shipment.

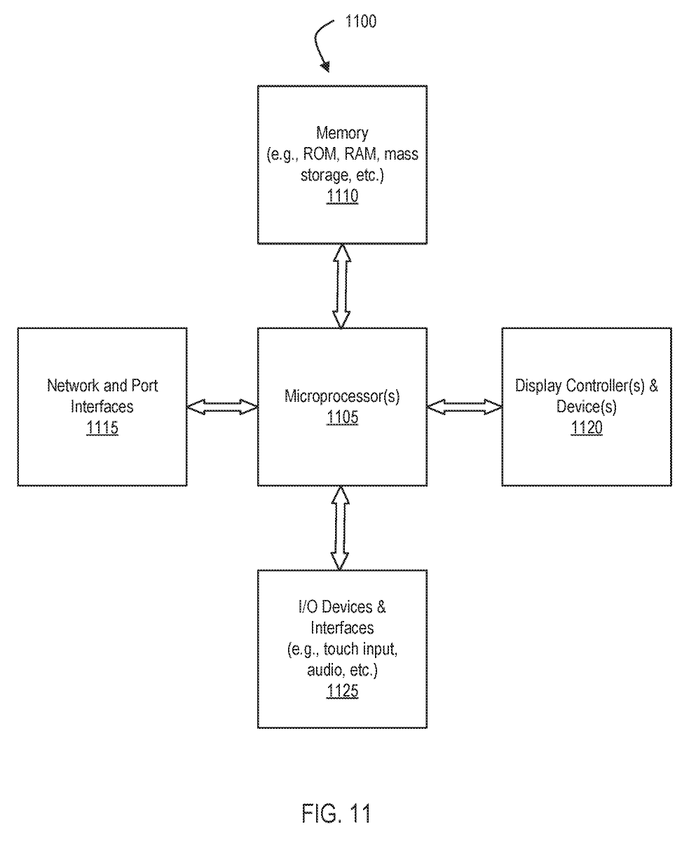

FIG. 11 illustrates, in block diagram form, an exemplary processing system to perform collaborative exchange. In some embodiments, this is a high-level view of social networking system 1130 described herein. Data processing system 1100 includes one or more microprocessors 1105 and connected system components (e.g., multiple connected chips). Alternatively, data processing system 1100 is a system on a chip.

Data processing system 1100 includes memory 1110, which is coupled to microprocessor(s) 1105. Memory 1110 may be used for storing data, metadata, and programs for execution by the microprocessor(s) 1105 including the modules and engines detailed above. For example, memory 1110 may include one or more of the data stores 101 and/or may store modules described herein. Memory 1110 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1110 may be internal or distributed memory.

Data processing system 1100 includes network and port interfaces 1115, such as a port, connector for a dock, or a connector for a USB interface, FireWire, Thunderbolt, Ethernet, Fibre Channel, etc. to connect the system 1100 with another device, external component, or a network. Exemplary network and port interfaces 1115 also include wireless transceivers, such as an IEEE 802.11 transceiver, an infrared transceiver, a Bluetooth transceiver, a wireless cellular telephony transceiver (e.g., 2G, 3G, 4G, etc.), or another wireless protocol to connect data processing system 1100 with another device, external component, or a network and receive stored instructions, data, tokens, etc.

Data processing system 1100 also includes display controller and display device 1120 and one or more input or output (“I/O”) devices and interfaces 1125. Display controller and display device 1120 provides a visual user interface for the user. I/O devices 1125 allow a user to provide input to, receive output from, and otherwise transfer data to and from the system. I/O devices 1125 may include a mouse, keypad or a keyboard, a touch panel or a multi-touch input panel, camera, optical scanner, audio input/output (e.g., microphone and/or a speaker), other known I/O devices or a combination of such I/O devices.

It will be appreciated that one or more buses, may be used to interconnect the various components shown in FIG. 11.

Data processing system 1100 is an exemplary representation of one or more of the systems described above. Data processing system 1100 may be a personal computer, tablet-style device, a personal digital assistant (PDA), a cellular telephone with PDA-like functionality, a Wi-Fi based telephone, a handheld computer which includes a cellular telephone, a media player, an entertainment system, or devices which combine aspects or functions of these devices, such as a media player combined with a PDA and a cellular telephone in one device. In other embodiments, data processing system 1100 may be a network computer, server, or an embedded processing device within another device or consumer electronic product. As used herein, the terms computer, device, system, processing system, processing device, and “apparatus comprising a processing device” may be used interchangeably with data processing system 1100 and include the above-listed exemplary embodiments.

Additional components, not shown, may also be part of data processing system 1100, and, in certain embodiments, fewer components than that shown in FIG. 11 may also be used in data processing system 1100. It will be apparent from this description that aspects of the inventions may be embodied, at least in part, in software. That is, the computer-implemented method(s) detailed herein may be carried out in a computer system or other data processing system 1100 in response to its processor or processing system 1105 executing sequences of instructions contained in a memory, such as memory 1110 or other non-transitory machine-readable storage medium. The software may further be transmitted or received over a network (not shown) via network interface device 1115. In various embodiments, hardwired circuitry may be used in combination with the software instructions to implement the present embodiments. Thus, the techniques are not limited to any specific combination of hardware circuitry and software, or to any particular source for the instructions executed by data processing system 1100.

An article of manufacture may be used to store program code providing at least some of the functionality of the embodiments described above. Additionally, an article of manufacture may be used to store program code created using at least some of the functionality of the embodiments described above. An article of manufacture that stores program code may be embodied as, but is not limited to, one or more memories (e.g., one or more flash memories, random access memories—static, dynamic, or other), optical disks, CD-ROMs, DVD-ROMs, EPROMs, EEPROMs, magnetic or optical cards or other type of non-transitory machine-readable media suitable for storing electronic instructions. Additionally, embodiments of the invention may be implemented in, but not limited to, hardware or firmware utilizing an FPGA, ASIC, a processor, a computer, or a computer system including a network. Modules and components of hardware or software implementations can be divided or combined without significantly altering embodiments of the invention.

As detailed herein, some embodiments of a method for . . . include [all of the clauses of the independent method claim]. Additionally, some embodiments of the method further include one or more of: 1) dependent claim 1; 2) dependent claim 2; etc.

As detailed herein, some embodiments of a non-transitory machine-readable medium storing instructions for . . . include [all of the clauses of the independent method claim]. Additionally, some embodiments further include one or more of: 1) dependent claim 1; 2) dependent claim 2; etc.

As detailed herein, some embodiments of an apparatus for . . . include [all of the clauses of the independent method claim]. Additionally, some embodiments of the apparatus further include one or more of: 1) dependent claim 1; 2) dependent claim 2; etc.

It will be evident that various modifications may be made thereto without departing from the broader spirit and scope of the invention as set forth in the following claims. For example, the methods described herein may be performed with fewer or more features/blocks or the features/blocks may be performed in differing orders. Additionally, the methods described herein may be repeated or performed in parallel with one another or in parallel with different instances of the same or similar methods.

What is claimed is:

1. A computer-implemented method comprising:
receiving parameters for a collaborative exchange;
curating a collection of items for the collaborative exchange based upon the received parameters;
transmitting the collection of items to participants of the collaborative exchange;
receiving selections of items from the participants of the collaborative exchange;
upon all participants having a turn at selecting an item, initiating shipment of the selected items.

2. The computer-implemented method of claim 1, wherein the parameters include at least one of a price range, a listing of participants, a vendor selection, and a catalog of items selection to contribute to the collaborative exchange.

3. The computer-implemented method of claim 1, further comprising:
suggesting users to participate using social signals including as social proximity in a social graph, geographic data, and personal data.

4. The computer-implemented method of claim 1, wherein the curating is based at least in part on the participants of the collaborative exchange.

5. The computer-implemented method of claim 1, wherein the turns at selecting an item are time limited.

6. The computer-implemented method of claim 1, further comprising:
transmitting identifying information and indications of items selected to the participants for display.

7. The computer-implemented method of claim 1, further comprising:
receiving and processing payment for the selected items.

8. The computer-implemented method of claim 1, further comprising:
receiving and forwarding payment information for the selected items to a vendor.

9. The computer-implemented method of claim 1, wherein the curating is based at least in part on the participants of the collaborative exchange.

10. A non-transitory computer-readable medium storing instructions which, when executed by one or more processors in a processing device, cause the processing device to perform a method comprising:
receiving parameters for a collaborative exchange;
curating a collection of items for the collaborative exchange based upon the received parameters;
transmitting the collection of items to participants of the collaborative exchange;
receiving selections of items from the participants of the collaborative exchange;
upon all participants having a turn at selecting an item, initiating shipment of the selected items.

11. The non-transitory computer-readable medium of claim 10, wherein the parameters include at least one of a price range, a listing of participants, a vendor selection, and a catalog of items selection to contribute to the collaborative exchange.

12. The non-transitory computer-readable medium of claim 10, further comprising:
suggesting users to participate using social signals including as social proximity in a social graph, geographic data, and personal data.

13. The non-transitory computer-readable medium of claim 10, wherein the curating is based at least in part on the participants of the collaborative exchange.

14. The non-transitory computer-readable medium of claim 10, wherein the turns at selecting an item are time limited.

15. The non-transitory computer-readable medium of claim 10, further comprising:
transmitting identifying information and indications of items selected to the participants for display.

16. The non-transitory computer-readable medium of claim 10, further comprising:
receiving and processing payment for the selected items.

17. The non-transitory computer-readable medium of claim 10, further comprising:
receiving and forwarding payment information for the selected items to a vendor.

18. The non-transitory computer-readable medium of claim 10, wherein the curating is based at least in part on the participants of the collaborative exchange.

19. An apparatus comprising:
a memory to store instructions;
a hardware processing device to execute the stored instructions to cause the apparatus to:
receive parameters for a collaborative exchange;
curate a collection of items for the collaborative exchange based upon the received parameters;
transmit the collection of items to participants of the collaborative exchange;
receive selections of items from the participants of the collaborative exchange;
upon all participants having a turn at selecting an item, initiate shipment of the selected items.
